(19) United States
(12) Patent Application Publication
(10) Pub. No.: US 2011/0156686 A1
(43) Pub. Date: Jun. 30, 2011

(54) LDO REGULATOR WITH LOW QUIESCENT CURRENT AT LIGHT LOAD

(75) Inventors: Vikram Gakhar, Bangalore (IN); Preetam Charan Anand Tadeparthy, Bangalore (IN)

(73) Assignee: Texas Instruments Incorporated, Dallas, TX (US)

(21) Appl. No.: 12/649,051

(22) Filed: Dec. 29, 2009

(51) Int. Cl. G05F 1/10

(52) U.S. Cl. 323/284

(57) ABSTRACT

A low dropout (LDO) regulator includes an amplifier having an input terminal, an output terminal; a first bias source and a second bias source, the first and second bias sources receiving a supply voltage, and a pass transistor and a sense transistor. Sources of the pass transistor and sense transistor are coupled to each other that receive the supply voltage. Gates of the pass transistor and sense transistor coupled to each other and to the output terminal of the amplifier. The LDO further includes a detection circuit responsive to a load current to deactivate the second bias source such that quiescent current in the amplifier is reduced. The detection circuit comprises a comparator coupled across a resistor. The resistor is coupled to a drain of the sense transistor.

### TECHNICAL FIELD

Embodiments of the disclosure relate to a low dropout (LDO) regulator with low quiescent current.

### BACKGROUND

A significant portion of power dissipation in an LDO in a portable application is during the time the LDO is turned on, but not loaded. It is desired to reduce power dissipation as much as possible when the LDO is not loaded. Quiescent current may be defined as the current drawn by a circuit (the LDO in this case) at no load condition. Higher quiescent current translates to higher gain and higher gain improves performance. However, at light loads, some of these parameters become better automatically, reducing the requirement for higher quiescent current. Many of the performance parameters of an LDO such as noise, power supply rejection ratio (PSRR) and accuracy depend on the gain of the amplifier, which in turn is a function of the quiescent current. Noise in the LDO reduces because of lower bandwidth. PSRR increases due to higher impedance of the pass transistor, shielding the output from the input. And since the load current is low, DC accuracy is not affected by load regulation. Thus it can be concluded that quiescent current can be reduced at light loads without sacrificing performance. A circuit to reduce quiescent current at light load increases the efficiency of the LDO.

### SUMMARY

An example embodiment provides a low dropout (LDO) regulator. The LDO regulator includes an amplifier having an input terminal and an output terminal; and a first bias source and a second bias source, the first and second bias sources receiving a supply voltage, and a pass transistor and a sense transistor. Sources of the pass transistor and sense transistor are coupled to each other that receive the supply voltage. Gates of the pass transistor and sense transistor are coupled to each other and to the output terminal of the amplifier. The LDO further includes a detection circuit that is responsive to a load current to deactivate the second bias source such that quiescent current in the amplifier is reduced. The detection circuit comprises a comparator coupled across a resistor. The resistor is coupled to a drain of the sense transistor.

An example embodiment provides a low dropout (LDO) regulator. The LDO regulator includes an amplifier having an input terminal and an output terminal; and a first bias source and a second bias source, the first and second bias sources receiving a supply voltage, and a pass transistor and a sense transistor. Sources of the pass transistor and sense transistor are coupled to each other that receive the supply voltage. Gates of the pass transistor and sense transistor are coupled to each other and to the output terminal of the amplifier. The LDO further includes a detection circuit that is responsive to a load current to deactivate the second bias source such that quiescent current in the amplifier is reduced. The detection circuit comprises a constant current source coupled to a drain of the sense transistor.

An example embodiment provides a low dropout (LDO) regulator. The LDO regulator includes an amplifier having an input terminal and an output terminal; and a first bias source and a second bias source, the first and second bias sources receiving a supply voltage, and a pass transistor and a sense transistor. Sources of the pass transistor and sense transistor are coupled to each other that receive the supply voltage. Gates of the pass transistor and sense transistor are coupled to each other and to the output terminal of the amplifier. The LDO further includes a detection circuit coupled to a source of the sense transistor. The detection circuit comprises a comparator coupled across a resistor. The resistor coupled to the source of the sense transistor. The detection circuit is responsive to a load current to deactivate the second bias source such that quiescent current in the amplifier is reduced.

Other aspects and example embodiments are provided in the Drawings and the Detailed Description that follows.

### BRIEF DESCRIPTION OF THE VIEWS OF DRAWINGS

FIG. 1 illustrates a low dropout (LDO) regulator with low quiescent current according to an embodiment;

FIG. 2 illustrates a low dropout (LDO) regulator with low quiescent current according to another embodiment; and

FIG. 3 illustrates a low dropout (LDO) regulator with low quiescent current according to another embodiment.

### DETAILED DESCRIPTION OF THE EMBODIMENTS

Embodiments of the disclosure provide a low dropout (LDO) regulator with low quiescent current. Various embodiments include a detection circuit that detects a light load and generates a sense signal at light loads. The sense signal deactivates a part of the bias source that biases the amplifier of the LDO so that quiescent current in the amplifier flowing through that part of the bias element is eliminated, which in effect reduces the quiescent current in the amplifier. Various embodiments are explained using an LDO regulator as an example. However, it will be appreciated that various embodiments can be used in other voltage regulators.

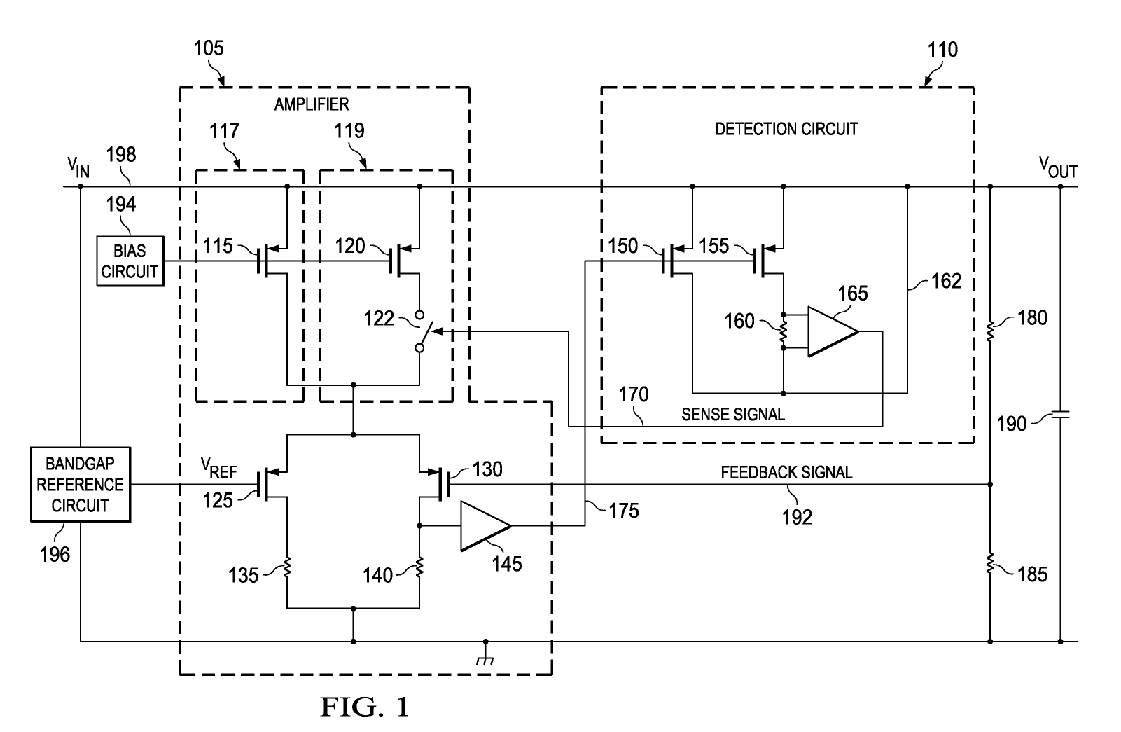

Various embodiments include LDOs with various detection circuits that control the amplifier are illustrated in FIGS. 1, 2 and 3. Referring now to FIG. 1, the LDO includes an amplifier 105 having an input terminal and an output terminal, and a first bias source 117 and a second bias source 119. The bias sources in an embodiment include MOS transistors. The first bias source 117 includes the transistor 115 and the second bias source 119 includes a transistor 120. Sources of the transistors 115 and 120 receive supply voltage VIN on a line 198. Gates of the transistors 115 and 120 receive bias voltage from the bias circuit 194. Drains of the transistors 115 and 120 are connected to each other and to sources of another pair of transistors 125 and 130. A switch 122 is connected to the drain of the transistor 120 that can disconnect the transistor 120 from the transistors 125 and 130. A gate of the transistor 125 receives reference voltage VREF from a bandgap reference circuit 196. A gate of the transistor 130 receives a feedback signal on a line 192. A resistor 135 is connected to the drain of the transistor 125 and a resistor 140 is connected to the drain of the transistor 130 respectively. Resistors 135 and 140 are connected to each other and to the ground. Drain of the transistor 130 is also connected to a circuit 145. An output of the amplifier 105 is taken from the output of the circuit 145 and is provided to the detection circuit 110. The output terminal of the amplifier 105 is defined on a line 175.

The detection circuit 110 includes a pass transistor 150 and a sense transistor 155. Sources of the pass transistor 150 and sense transistor 155 are coupled to each other that receive the supply voltage. Gates of the pass transistor 150 and sense transistor 155 coupled to each other and to the output terminal of the amplifier (line 175). A drain of the pass transistor 150 is connected to the output of the LDO. A drain of the sense transistor 155 is connected to the output of the LDO through a resistor 160. A comparator 165 is connected across the resistor 160. An output of the comparator 165 is connected to the switch 122 on a line 170. The output of the comparator 165 is referred to as a sense signal. A capacitor 190 is connected at the output of the LDO for fast buffering to accommodate load transients. A pair of resistors (180 and 185) is parallel to the capacitor 190. Feedback signal is generated from a point between the resistor 160 180 and 185. Ratio of the resistor 160s 180 and 185 defines the output voltage of the LDO.

In operation, the detection circuit detects a light load and generates the sense signal (line 170) that deactivates the switch 122. Operation of the detection circuit 110 according to an embodiment is discussed now. It is noted that the sense transistor 155 is smaller (a small fraction of) than the pass transistor 150. Since the sense transistor 155 has the same gate and source connection as the pass transistor 150, but its drain is connected to the output through the resistor 160, the sense transistor 155 functions like a current mirror to the pass transistor 150. So, the voltage across the resistor 160 is proportional to the load current. The comparator 165, with intentional offset and hysteresis, trips if the voltage across the resistor 160 falls below a predetermined threshold value and generates the sense signal. The sense signal deactivates the switch 122 such that bias source 119 is deactivated. Hence, the current dissipates only through the first bias source 117 thereby quiescent current in the amplifier is reduced.

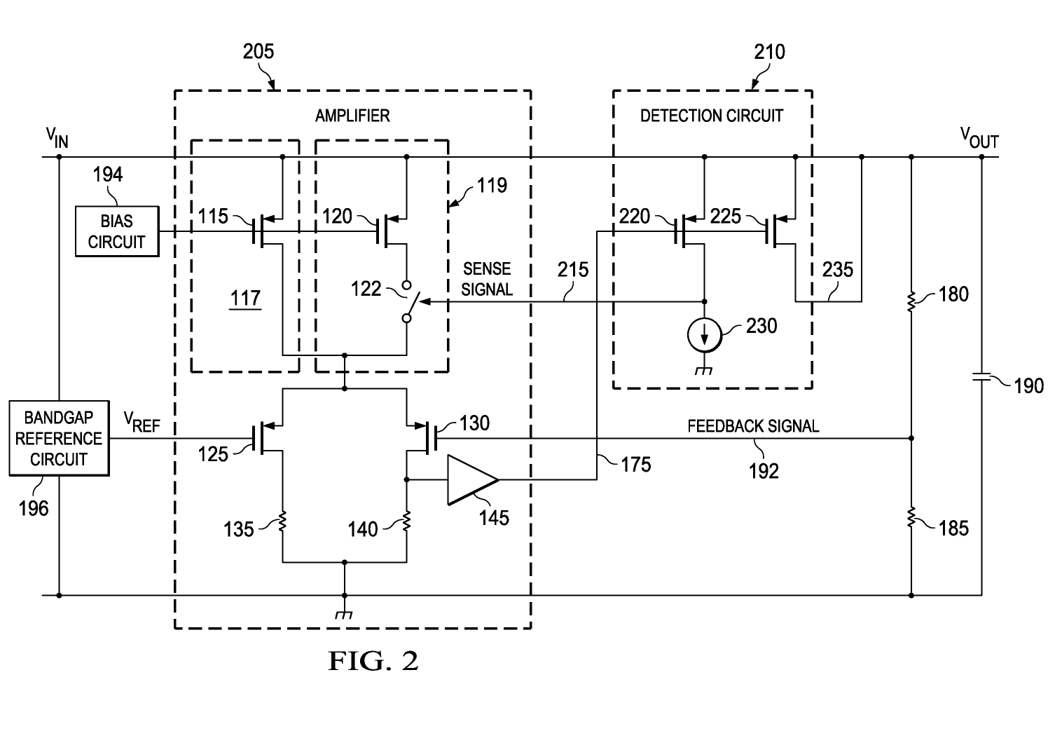

Another detection circuit 210 in the LDO according to an embodiment is illustrated in FIG. 2. The LDO of FIG. 2 is similar to that of the LDO as illustrated in FIG. 1 except for the detection circuit 210. The detection circuit 210 includes a pass transistor 225 and a sense transistor 220. Sources of the pass transistor 225 and sense transistor 220 are coupled to each other that receive the supply voltage. Gates of the pass transistor 225 and sense transistor 220 are coupled to each other and to the output terminal of the amplifier (line 175). A drain of the pass transistor 225 is connected to the output of the LDO. A drain of the sense transistor 220 is connected to a constant current source 230. A sense signal is generated from a point between the drain of the sense transistor 220 and the constant current source 230 on a line 215.

In operation, since the sense transistor 220 has the same gate to source voltage (VGS) as the pass transistor 225, the sense transistor 220 carries a current proportional to that of the pass transistor 225. This also means that the current that sense transistor 220 carries is proportional to the load current. If the current flowing through the sense transistor 220 is I_{SENSE} and the current flowing through the pass transistor 225 is I_{OUT}, then I_{SENSE}=αI_{OUT}.

If I_{SENSE} is greater than I_{REF}, wherein I_{REF} is the current flowing through the constant current source 230, it is an indication that the output current is higher than the threshold I_{REF}/α. If I_{SENSE} is smaller than I_{REF}, it is an indication that the output current is lower than the threshold I_{REF}/α. The sense signal can be accordingly generated, and as explained earlier, the switch 122 is deactivated to reduce the quiescent current in the amplifier 105.

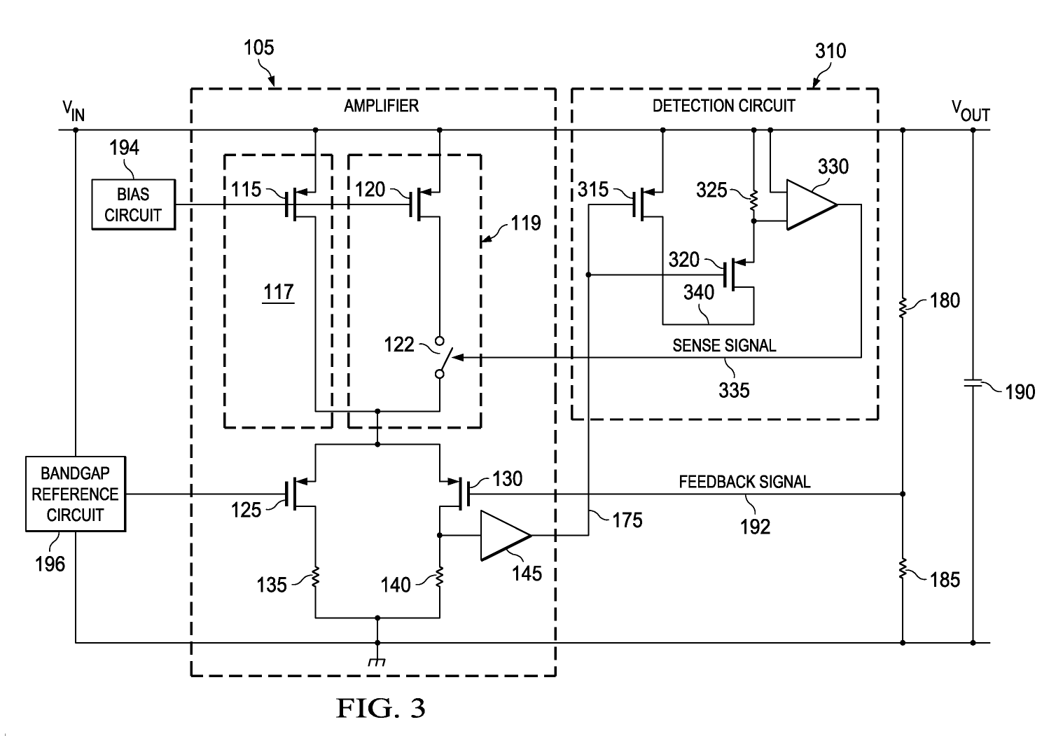

Another detection circuit 310 in the LDO according to an embodiment is illustrated in FIG. 3. The LDO of FIG. 3 is similar to that of the LDO as illustrated in FIGS. 1 and 2 except for the detection circuit 310. The detection circuit 310 includes a pass transistor 315 and a sense transistor 320. Gates of the pass transistor 315 and the sense transistor 320 are coupled to each other and to the output terminal of the amplifier (line 175). Drains of the pass transistor 315 and the sense transistor 320 are coupled to each other. A source of the pass transistor 315 is connected to the supply voltage V_{IN}. A source of the sense transistor 320 325 is connected to the supply voltage through a resistor 325. A comparator 330 is connected across the resistor 325. An output of the comparator 330 is connected to the switch 122 on a line 335.

In operation, the sense transistor 320 carries a small fraction of the pass transistor 315 current. The current through the sense transistor 320 passes through the resistor 325. The voltage across the resistor 325 is proportional to the load current. The comparator 330, with intentional offset and hysteresis, trips if the voltage across the resistor 325 falls below a predetermined threshold value and generates the sense signal. The sense signal deactivates the switch 122 such that bias source 119 is disconnected, which in turn reduces the quiescent current in the amplifier. From the foregoing discussion it is clear that various embodiments reduce quiescent current of the LDO at no load is saved without sacrificing the performance.

In the foregoing discussion, the term “connected” means at least either a direct electrical connection between the devices connected or an indirect connection through one or more passive or active intermediary devices. The term “circuit” means at least either a single component or a multiplicity of components, either active or passive, that are connected together to provide a desired function. The term “signal” means at least one current, voltage, charge, data, or other signal. It is to be understood that the term transistor can refer to devices including MOSFET, PMOS, and NMOS transistors. Furthermore, the term transistor can refer to any array of transistor devices arranged to act as a single transistor.

The forgoing description sets forth numerous specific details to convey a thorough understanding of the invention. However, it will be apparent to one skilled in the art that the invention may be practiced without these specific details. Well-known features are sometimes not described in detail in order to avoid obscuring the invention. Other variations and embodiments are possible in light of above teachings, and it is thus intended that the scope of invention not be limited by this Detailed Description, but only by the following Claims.

What is claimed is:

1. A low dropout regulator comprising:
an amplifier having an input terminal, an output terminal, a first bias source and a second bias source, the first and second bias sources receiving a supply voltage;
a pass transistor and a sense transistor, sources of the pass transistor and sense transistor coupled to each other and receiving the supply voltage, gates of the pass transistor and sense transistor coupled to each other and to the output terminal of the amplifier; and
a detection circuit responsive to a load current to deactivate the second bias source such that quiescent current in the amplifier is reduced, the detection circuit comprising a comparator coupled across a resistor, the resistor coupled to a drain of the sense transistor.

2. The low dropout regulator of claim 1, wherein the sense transistor is smaller than the pass transistor.

3. The low dropout regulator of claim 1, wherein the sense transistor functions as a current mirror to the pass transistor.

4. The low dropout regulator of claim 1, wherein a voltage across the resistor is proportional to the load current.

5. The low dropout regulator of claim 4, wherein the comparator compares the voltage across the resistor and generates a sense signal when the voltage is lower than a threshold.

6. The low dropout regulator of claim 5, wherein the sense signal deactivates a switch coupled to the second bias source such that current dissipates through the first bias source thereby quiescent current in the amplifier is reduced.

7. The low dropout regulator of claim 1, wherein the amplifier receives a reference voltage and a feedback signal, the feedback signal being generated from a resistor divider at an output of the low dropout regulator.

8. A low dropout regulator comprising:
an amplifier having an input terminal ,an output terminal, a first bias source and a second bias source, the first and second bias sources receiving a supply voltage;
a pass transistor and a sense transistor, sources of the pass transistor and sense transistor coupled to each other and receiving the supply voltage, gates of the pass transistor and sense transistor coupled to each other and to the output terminal; and
a detection circuit responsive to a load current to deactivate the second bias source such that quiescent current in the amplifier is reduced; the detection circuit comprising a constant current source coupled to a drain of the sense transistor.

9. The low dropout regulator of claim 8, wherein the sense transistor is smaller than the pass transistor.

10. The low dropout regulator of claim 8, wherein a current flowing through the sense transistor is proportional to the load current.

11. The low dropout regulator of claim 10, wherein a sense signal is generated if the current flowing through the sense transistor is lower than the current flowing through the constant current source.

12. The low dropout regulator of claim 11, wherein the sense signal deactivates a switch coupled to the second bias source such that current dissipates through the first bias source thereby quiescent current in the amplifier is reduced.

13. A low dropout regulator comprising:
an amplifier having an input terminal ,an output terminal, a first bias source and a second bias source, the first and second bias sources receiving a supply voltage;
a pass transistor and a sense transistor, drains of the pass transistor and sense transistor coupled to each other and coupled to an output of the low dropout regulator, gates of the pass transistor and sense transistor coupled to each other and to the output terminal; and
a detection circuit coupled to a source of the sense transistor, the detection circuit comprising a comparator coupled across a resistor, the resistor coupled to the source of the sense transistor, wherein the detection circuit is responsive to a load current to deactivate the second bias source such that quiescent current in the amplifier is reduced.

14. The low dropout regulator of claim 13, wherein the sense transistor is smaller than the pass transistor.

15. The low dropout regulator of claim 13, wherein a voltage across the resistor is proportional to the load current.

16. The low dropout regulator of claim 15, wherein the comparator compares the voltage across the resistor and generates a sense signal when the voltage is lower than a threshold.

17. The low dropout regulator of claim 16, wherein the sense signal deactivates a switch coupled to the second bias source such that current dissipates through the first bias source thereby quiescent current in the amplifier is reduced.
